(19) United States
(12) Patent Application Publication
(10) Pub. No.: US 2008/0307473 A1
(43) Pub. Date: Dec. 11, 2008

(54) Virtual worlds pay-per-view

(75) Inventor: Timothy M. Allen, Lafayette Hill, PA (US)

Correspondence Address: BUCHANAN, INGERSOLL & ROONEY PC, POST OFFICE BOX 1404, ALEXANDRIA, VA, 22313-1404, US

(73) Assignee: Virtual Worlds PPV, LLC, Philadelphia, PA (US)

(21) Appl. No.: 11/808,094

(22) Filed: Jun. 6, 2007

(51) Int. Cl. H04N 7/173; G06F 3/048

(52) U.S. Cl. 725/104; 715/757

(57) ABSTRACT

A pay per view program is provided in a virtual world such that users can share the experience of viewing the same pay per view program simultaneously through a virtual world interface. By providing pay per view programs in a virtual world, users of the virtual world can be exposed to a shared common experience, and can interact in the virtual world while experiencing the pay per view program.

### BACKGROUND

Virtual worlds are computer-based simulated environments intended for its users to inhabit and interact via avatars. Avatars in virtual worlds can be virtual images or representations such as humanoids, or any other representation of a user, and can be in the form of two or three-dimensional graphical representations. Virtual worlds are generally purposed for interaction between users with one another and with computer-based simulated environments.

Massively Multiplayer Online Role Playing Games (MMORPG) utilize virtual worlds and can include millions of users who often play these games, rather than playing single player stand-alone computer games on their personal console, because of the user interaction. In general, MMORPGs fall into two categories: interaction driven and goal driven.

In interaction driven MMORPGs, interaction with other users is the primary goal and there are no specific goals or specific purposes, such as scores, points, etc. Examples of these types of MMORPGs include Second Life™, There™, or ActiveWorlds™.

In these virtual worlds, the users within the world primarily interact with each other, and interaction with computer systems often occurs to provide tools for interaction between the users. For example, the virtual world platform can be used as a toolbox, wherein the computer system creators, designers, etc. can provide tools to allow the users to build and customize their avatars, as well as items for use by their avatars, such as clothes or houses, etc. Basically, the computer system allows customization of the universe, or “metaverse,” as desired by the user within the confines of the computer-based simulated environments.

In goal driven MMORPGs, on the virtual worlds are built to include goals and specific purposes defined by the computer system. For example, World of Warcraft™, Eve Online™, and City of Heroes™ have quests and levels in which users interact with the computer system to advance their avatar through a series of goals to progress their avatar from having low level abilities and gear to having higher level abilities and gear.

In these games, professional content creators provide the goals (e.g., quests) and gear, while the users interact with other users to assist one another in completing the quests and the attaining the gear. For example, the computer system sets forth quests and items required for the quests such that the users can then attempt to complete these quests by gathering these items within the computer-based simulated environments.

In all MMORPGs, however, the driving forces behind the games are the user interactions and the alternative realities offered. By entering computer-based simulated environments, users can be anyone or anything and can role play with different appearances and personalities and do things differently than they might in real life.

Additionally, shared common experiences, such as group questing (e.g., where avatars group and pursue a common quest) or group socializing (e.g., where avatars go to a nightclub or bar to interact), are also very common. Streaming video support has been recently introduced into virtual worlds wherein the video is shown on screens within the virtual world. However, content for these shared common experiences has been limited, and thus far content providers have been unable to provide content for viewing as part of a shared common experience on a pay per view basis.

### SUMMARY

In one exemplary embodiment, a human user in a virtual world can select viewable content, such as a pay per view (PPV) program, and can order and view the selected viewable content viewable by more than one human user in the virtual world in a shared common computer-based simulated virtual world environment.

In another exemplary embodiment, a user can order viewable content on a pay per view basis by interacting with an item in a computer-based simulated environment and being directed to a list of available viewable content through which the user can select viewable content for viewing by the user as simulated by the user's avatar.

In another exemplary embodiment, a user can have a virtual entertainment system and can order viewable content on a pay per view basis to be shown on the virtual entertainment system, wherein the user can have other users' avatars experience the viewable content through the virtual entertainment system for a shared common experience during which the avatars can communicate with one another.

In another exemplary embodiment, a virtual world system, comprising a computer processor and storage device capable of providing a virtual world including virtual environments, avatars for human users, and an interactive virtual interface; allowing the human users to interact with other human users and the interactive virtual interface within the virtual environment; and providing viewable content on a pay per view basis within the virtual world based upon the human users' interaction with the interactive virtual interface, wherein the viewable content is viewable visually and audibly to human users if their avatars are within a predetermined area in the virtual world, is provided.

In another exemplary embodiment, a method of providing viewable content in a virtual world, comprising providing a virtual world including virtual environments, avatars for human users, and an interactive virtual interface; allowing the human users to interact with other human users and the interactive virtual interface within the virtual environment; and providing viewable content on a pay per view basis within the virtual world based upon the human users' interaction with the interactive virtual interface, wherein the viewable content is transmitted into the virtual world and is made available on a pay per view basis to human users whose avatars are within a predetermined area in the virtual world.

### BRIEF DESCRIPTION OF THE DRAWING FIGURES

FIG. 1 illustrates an exemplary embodiment of a computer monitor displaying avatars viewing viewable content on a pay per view basis purchased for viewing in the virtual world.

FIG. 2 illustrates an exemplary embodiment of a computer monitor displaying a menu system for ordering viewable content on a pay per view basis for viewing in the virtual world.

FIG. 3 illustrates an exemplary embodiment of a computer network including local computers and servers.

FIG. 4 illustrates a flow chart of an exemplary embodiment for ordering viewable content on a pay per view basis for viewing in the virtual world.

### DETAILED DESCRIPTION

In exemplary embodiments as described herein, a user can order and view viewable content in a computer-based simulated environment with other users, wherein the functionality of the computer-based simulated environment allows for the simultaneous viewing and hearing, on a pay per view basis, of the viewable content and interaction between virtual world, locally situated users.

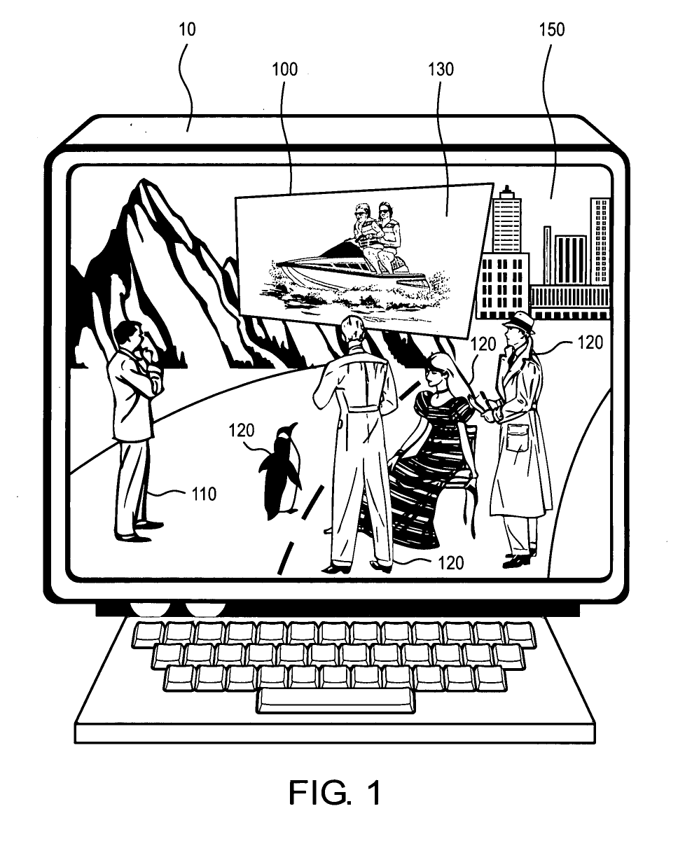

In FIG. 1, an exemplary computer monitor 10 displaying a screen shot 150 from a MMORPG is illustrated as would be viewed by a MMORPG user. As illustrated in the screen shot 150, an avatar 110 is shown within the screen shot 150 watching viewable content 130 on a virtual viewing device 100 while being able to view and interact with other avatars 120 within the MMORPG environment. Also illustrated within the screen shot 150 are other avatars 120 (e.g., the humans and the penguin), wherein the MMORPG users who are represented by these avatars 120 can also simultaneously view, on a pay per view basis, the same viewable content 130 on the virtual viewing device 100 on their own computer monitors, as well as interact with and view other MMORPG users through their avatars 110, 120.

An example of what a computer monitor 10 would display for a single MMORPG user is illustrated in FIG. 1, with an avatar 110 to the left, looking at a virtual viewing device 100 within the virtual world. In a sense, there is a virtual three-dimensional “screen within a screen” in that the MMORPG user is looking at their own computer monitor 10 screen to watch a virtual viewing device 100 “screen” therein. As mentioned above, any additional avatars (e.g., other MMORPG users' avatars or computer controlled avatars), such as avatars 120, within a predetermined virtual viewing distance of the virtual viewing device 100 can see the viewable content 130. In this illustration, the virtual viewing device 100 is showing previously selected and purchased viewable content 130, wherein the avatars 110, 120 are watching viewable content 130 of people riding a watercraft vehicle on the virtual viewing device 100. Hence, any users whose avatars 110, 120 are in the predetermined area can watch their computers and see both the viewable content 130 on the virtual viewing device 100 and the avatars 110, 120, as well as be able to interact with other users through chats, tells, emotes, VoIP (Voice over Internet Protocol), etc.

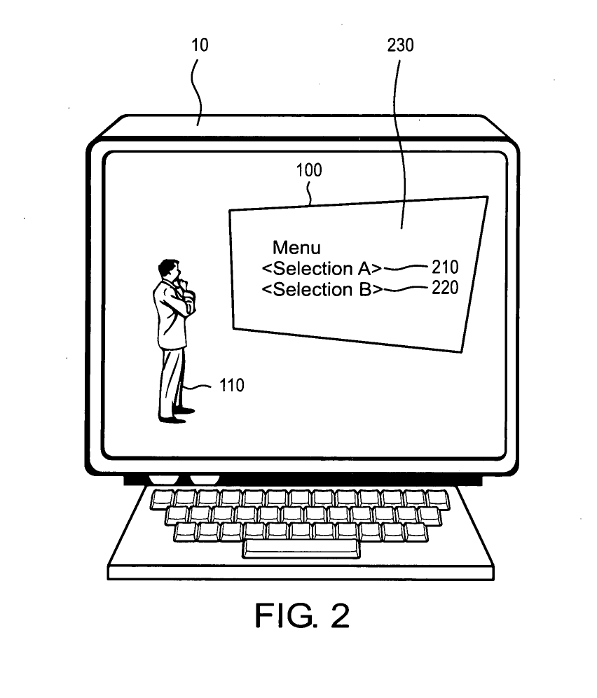

In FIG. 2, a computer monitor 10 is illustrated displaying an interactive virtual interface 230, which can resemble a menu of available options, within a virtual viewing device 100. The interface 230 illustrates a first available option “<Selection A>” 210 and a second available option “<Selection B>” 220, however, more than two available options are contemplated. A user 110 can choose one of the options from the interface 230. The chosen option (e.g., “<Selection A>”) can represent the selection of a specific viewable content (e.g., a title of a movie), wherein the selection of this specified viewable content can be similar to a PPV program. Alternatively, the selection can lead to a sublist of viewable content for selection, or a link to an external website. Examples of sublists can include: types of programs, such as Comedy, Action, Children's programming, etc.; Motion Picture ratings, and other information (copyright year, length, etc.); costs for the viewable content; etc. The link to the external website can be a hyperlink or other forwarding mechanism to direct the user to a list of available viewable content not viewed through the virtual viewing device 100.

After selection of the particular option through the interface 230, the viewable content 130 corresponding to that option can be made available on the virtual viewing device 100. It is contemplated that the viewable content 130 can be made available immediately, or any time in the future such that a social gathering of users to view the viewable content 130 can be scheduled if desired.

A user can use the interface 230 to view and select what media (e.g., movies, television programming, sporting events, concerts, etc.) they want to access on the virtual viewing device 100, which can resemble images of television or movie screens within the virtual world. The virtual viewing device 100 can be a rectangular shape, which can already exist in the virtual world. Alternatively, the virtual viewing device 100 can be created in any number of manners, including having one coded into the virtual world's client software, or having the user drag an item from their virtual inventory to the location they wish the virtual viewing device 100 to appear in the virtual world. The normal video content playback options (e.g., play, rewind, pause, stop, fast forward, fast rewind, skip, etc.) can be controlled through an interface (not shown) in the virtual world and/or an interface in the real world for use by the MMORPG users.

The virtual viewing device 100 can be made in any shape or size, and would not be constrained within the virtual world. In other words, the virtual viewing device 100 can be made as small or as large as desired, and can be placed anywhere without requiring mounts or stands, and can be viewed at any angle. Alternatively, the virtual viewing device 100 can be constrained by “real life” constraints, such as limited “realistic” viewing angles of the viewing surface of the virtual viewing device 100 or requiring mounting of the virtual viewing device 100 on a wall or on a pedestal.

As mentioned above, the interface 230 to select the viewable content that the user would like to purchase from within the virtual world's own program interface controls, a separate interface program, or even a website. Once the screen is clicked, a menu will appear that allows the user to browse or search for the viewable content they would like to purchase. Once the user selects the viewable content, they are instructed to pay.

A menu in the interface 230 can be made accessible to the user with any number of tools, such as a web browser, or using the virtual world's own user interface controls. The code is written to allow the user to select the viewable content they wish to view, and the ability to communicate in and out of the virtual world can be stored as part of this screen or elsewhere within the client application.

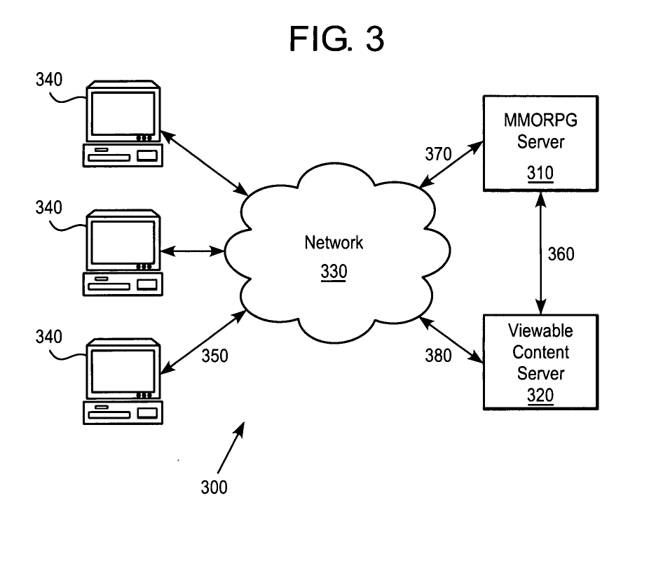

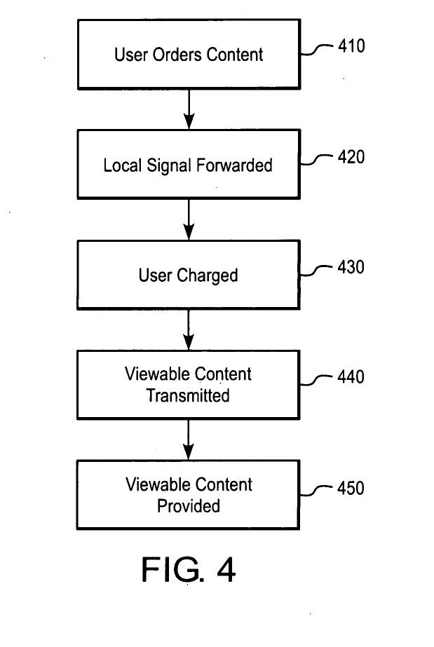

One example of how viewable content can be provided to a user is as follows and illustrated in FIGS. 3 and 4. As illustrated in FIG. 3, a system 300 including a MMORPG server 310, a viewable content server 320, a network 330, and local computers 340 can be provided.

First, as shown in FIG. 4, a user can select viewable content 410, for example from the menu illustrated in FIG. 2 by activating a section of the interface 230. It is contemplated that this selection can be accomplished by a mouse click on a particular selection from a menu listed on the interface 230 or, as another example, the user can select viewable content by activating a section of the interface 230 and be forwarded to an external website for selection of the viewable content, although any method for selection of the option can be used.

Second, this selection along with personal information about the user, such as their name or other identifier and payment information, can be forwarded 420. Alternatively or additionally, information about the user's avatar can be forwarded. The forwarded information 420 can be provided as a local signal 350 to the network 330 from a local computer 340 and in turn be forwarded through the network 330 to the MMORPG server 310 through a first signal 370 or to a viewable content server 320 through a second signal 380 to a viewable content server 320. It is noted that other information can be carried in the local signal 350, the first signal 370 and the second signal 380. For example, the virtual world graphics from the MMORPG server 310 are transmitted through the first signal 370 through the network 330 and to the local computer 340 through the local signal 350.

Third, the user can be charged 430 by the viewable content server 320 for the viewable content 130. This can occur by a computer process of authorizing payment to the viewable content provider or recognizing a user and the user's corresponding account, etc.

Fourth, the viewable content 130 can be transmitted 440 from, for example, an internal database within the virtual world (e.g., the MMORPG server 310 or databases linked thereto) or an external database networked to the virtual world system 300 (e.g., the viewable content server 320 or databases linked to the system 300) containing the available viewable content 130. The transmission, if provided by an external database, can be transferred in the form of a viewable content stream 360 to the MMORPG server 310. Thus, the virtual world location where the user's avatar is located can receive the viewable content 130, wherein the viewable content 130 can be uploaded into the virtual space where the user's virtual viewing device 100 is located.

Fifth, the viewable content can be provided 450 to the user while the user (and optionally other additional users) watches and interacts with the viewable content and the user's avatar (and optionally other additional users' avatars) simultaneously.

A number of different payment methods could be used, as mentioned above. For example, the user can input a financial card (e.g., a debit card, credit card or gift card) number within their user account in the virtual world, can input a financial card number directly through a pop-up standard payment interface, or can use virtual currency as part of the virtual world for use as payment for the viewable content. Payment methods, such as financial cards (e.g. credit and debit cards), Internet payment services, such as Paypal™, or virtual world currency, such as Linden Dollars, can be used. Once payment is made, a local signal 350 can be transmitted to the network and in turn to MMORPG server 310 or the viewable content server 320, wherein upon payment, the viewable content server 320 can provide a viewable content stream 360 to the MMORPG server 310 to provide the viewable content to the virtual viewing device 100.

In order to allow for the viewable content to be provided in the virtual worlds, a database can be employed, as mentioned above. Any SQL compliant database could be used to design the necessary database (e.g., Oracle, MySQL, or Microsoft SQL Servers), wherein sending and receiving data from the database to the virtual world, or creating any external interfaces can be done by using a programming language. Non-limiting examples of languages that could be used include Java, C, PHP, and ASP. Exemplary databases can provide storage for viewable content information, such as the name of the viewable content, the description, peer review ratings, motion picture content ratings, the price, the duration that the user can have access to the viewable content the methods of communicating with the virtual world in which the content is to be displayed, categories or genres of the available videos, to name a few.

The viewable content can be identified by a Uniform Resource Locator (URL). The URL can be used as a temporary URL for each individual instance of the viewable content accessed. The URL can then be programmed to automatically expire after the access time has ended.

Viewable content, as used herein, may be provided for a fixed fee for a period of time (e.g., a monthly subscription similar to Netflix™ or a daily subscription), or may be provided on a per use basis, or nearly any other basis. It is noted, as mentioned above, that the amount of time the virtual viewing device 100 has access to the viewable content can be determined on a per use or per charge basis, as desired.

The virtual worlds, as used herein, are networked for transferring the viewable content from a viewable content provider to the virtual viewing device 100 via the internet. In exemplary embodiments, a network server is used to transmit digitally encoded data and other information back and forth with a local computer (e.g., the computer attached to the computer monitor 10). The transmitted data and other information may represent a user's name and payment methods, a menu of viewable content and the user's selections.

Virtual World Communications Gateways

Currently, each virtual world would typically use a separately programmed gateway or internal interface to allow the information stored about the stream in the database, payment information, and other relevant data to be sent asynchronously between the database and the virtual world although other mechanisms currently developed or developed in the future could be used. This two-way communication stream is designed to check that the right amount of payment is made for the media, that it is given for the correct amount of time, and that the player is given a unique identifier or other suitable mechanism allowing for communications with the single in-world screen that may be one of many screens throughout the virtual world.

Each virtual world would likely use a separately programmed screen, which will reside within the virtual world for displaying the media URL received from the database through the communication gateway. These screens would typically be uniquely identified so that the communication gateway and database can uniquely identify one screen from another, as there may be many screens with many different users as owners within the virtual world. Other mechanisms might be possible, of course.

Each virtual world also would likely use at least one type of separately programmed menu interface although they might be common among two or more virtual worlds. This menu interface could be an extension of the viewing screen, using the virtual world's own program interface controls, a web site, or other interface controls to display or receive the category and stream data from the database to display to the user.

Each payment method could be implemented by a separately programmed communication gateway to allow for payment information to be received. Examples of a customized gateway would be Paypal's Instant Payment Notification (IPN) system, a credit card, or a virtual world's own internal currently as mentioned above. Using currently popular technology, each of these methods use a gateway between the database and the payment method. Certain payment methods could be integrated with the virtual world communication gateway. After the correct payment amount is received, a trigger would be sent through the virtual world communication gateway for example to allow the individual user's screen to display the PPV media stream for the allotted time period.

As mentioned above, a user can access a website from the interface 230, such as through a menu of viewable content. In an exemplary embodiment, the interface 230 can include a list of websites or a list of viewable content. The user can then select from the list, wherein the selection can be transmitted through the internet from the local computer to the network server, and the viewable content can be provided within the virtual world provided by the network server, or another network server, and the user can experience the viewable content through a virtual viewing device 100 within the virtual world.

Information required by the MMORPG server 310 on the offered viewable content 130 can be stored in a viewable content database 320 that can be internal or external to the virtual world network 300. For example, some viewable content 130 can be stored within the MMORPG server 310, while other viewable content 130 can be provided by third party vendors via their own viewable content server(s) 320.

It is noted that limits of viewable content may also be applied as desired. For example, if the portion of the virtual world that the virtual viewing device can be accessed by children, it is contemplated that parental controls or in-game virtual controls regarding the viewable content can be provided. For example, viewable content for mature audiences may be unavailable for particular virtual viewing devices.

Hence the present disclosure provides three levels of reality: the images of the viewable content; the avatars who interact with each other, the viewable content made accessible and provided on a pay per view basis, and virtual world objects; and the MMORPG users who interact with the viewable content, the virtual world including the avatars and the virtual world objects, each other and the MMORPG users' computer, and other real world objects.

Although the present invention has been fully described in connection with the exemplary embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A virtual world system, comprising:
a computer processor and storage device capable of:
providing a virtual world including:
virtual environments;
avatars for human users; and
an interactive virtual interface;
allowing the human users to interact with other human users and the interactive virtual interface within the virtual environment; and
providing viewable content within the virtual world on a pay per view basis, based upon the human users' interaction with the interactive virtual interface, wherein the viewable content is transmitted into the virtual world and is made available on a pay per view basis to human users whose avatars are within a predetermined area in the virtual world.

2. The system of claim 1, wherein the viewable content is a pay per view (PPV) program and the human users' interaction comprises virtual interaction between the human user and the interactive virtual interface.

3. The system of claim 2, wherein the virtual interaction comprises selecting and purchasing on a pay per view basis an item displayed within a menu on a computer display using a computer input device.

4. The system of claim 2, wherein the pay per view program is purchased by the human user, and wherein payment occurs on a monthly or per use basis.

5. The system of claim 1, wherein the viewable content is selected purchased on a pay per view basis from the group consisting of movies, television shows, sporting events, and concerts.

6. The system of claim 1, wherein both the viewable content made available on a pay per view basis and the avatars are viewed simultaneously by multiple human users, and
wherein the system allows communication within the virtual world between the multiple human users while the viewable content is viewed.

7. The system of claim 1, wherein the viewable content is transmitted into the virtual world after selection and payment on a pay per view basis by a human user is confirmed by the system, and wherein the system forwards the viewable content to a virtual viewing device within the predetermined area in the virtual world such that one or more human users can view on a pay per view basis the viewable content and avatars within an area of the virtual world simultaneously.

8. A method of providing viewable content in a virtual world on a pay per view basis, comprising:
providing a computer-based virtual world including:
virtual environments;
avatars for human users; and
an interactive virtual interface;
allowing the human users to interact with other human users and the interactive virtual interface within the virtual environment; and
providing viewable content on a pay per view basis within the virtual world based upon the human users' interaction with the interactive virtual interface, wherein the viewable content is transmitted into the virtual world and is made available on a pay per view basis to human users whose avatars are within a predetermined area in the virtual world.

9. The method of claim 8, wherein the providing the viewable content comprises providing a pay per view (PPV) program, and wherein the interaction between the human users comprises virtual interaction between at least one human user and the interactive virtual interface.

10. The method of claim 9, wherein the virtual interaction comprises selecting an item displayed within a menu on a computer display using a computer input device.

11. The method of claim 9, wherein the PPV program is paid by the human user, and wherein payment occurs on a monthly or per use basis.

12. The method of claim 8, wherein the providing the viewable content comprises displaying movies, television shows, sporting events, or concerts on a virtual viewing device within the virtual world.

13. The method of claim 8, further comprising allowing multiple human users to communicate within the virtual world, wherein the providing the viewable content on a pay per view basis comprises providing the viewable content simultaneously to multiple human users during which the multiple human users are provided capability by networks supporting the virtual world to communicate with one another within the virtual world.

14. The method of claim 8, wherein the providing the viewable content comprises confirming selection and payment by a human user, transmitting the viewable content from a database into the virtual world, and forwarding the viewable content to a virtual viewing device within the predetermined area in the virtual world such that one or more human users can simultaneously view the viewable content and avatars within an area of the virtual world.
